(19) United States
(12) Patent Application Publication
(10) Pub. No.: US 2016/0131180 A1
(43) Pub. Date: May 12, 2016

(54) CABLE SOCKET WITH ISOLATION FUNCTION AND TRANSMISSION CABLE HAVING THE SAME

(71) Applicants: HYUNDAI MOTOR COMPANY, Seoul (KR); Kia Motors Corporation, Seoul (KR)

(72) Inventors: Jong-Ho HONG, Seoul (KR); Joon-Young PARK, Suwon-si (KR); Wan-Kyo PARK, Suwon-si (KR); Jun-Sung AHN, Hwaseong-si (KR)

(21) Appl. No.: 14/802,946

(22) Filed: Jul. 17, 2015

(30) Foreign Application Priority Data
Nov. 12, 2014 (KR) 10-2014-0156957

(51) Int. Cl. F16C 1/10

(52) U.S. Cl. CPC F16C 1/101; F16C 1/108

(57) ABSTRACT

A cable socket has an isolation function attached to an end of a transmission cable which connects a transmission disposed in an engine compartment of a vehicle and a shift lever installed inside the vehicle. The cable socket includes a casing cap and a guide pipe connected to each other in the cable socket and extending outwardly from the cable socket. A rubber damper is attached to the casing cap at which the casing cap and the guide pipe are connected. An internal housing has an end of the guide pipe being inserted therein. An external housing is attached to the internal housing, in which the casing cap and the rubber damper are inserted. A pressure blocking member is inserted between the rubber damper and the external housing to block a pressure applied to the external housing from being transferred to the rubber damper.

### CROSS-REFERENCE TO RELATED APPLICATIONS

This application claims the benefit priority to Korean Patent Application No. 10-2014-0156957, filed on Nov 12, 2014, which is incorporated herein by reference in its entirety.

### TECHNICAL FIELD

The present disclosure relates to a cable socket dampening vibration at a transmission cable which transfers a shift operation of a driver to a transmission in a vehicle and the transmission cable having the same, and more particularly, to a cable socket capable of preventing an external force from acting into an internal member and having an isolation function without an additional damping member that transfers vibration, and a transmission cable having the same.

### BACKGROUND

Conventionally, a transmission and a shift lever of a vehicle are connected via a transmission cable to operate a transmission mounted in an engine room. A transmission operates by an operating force transferred to the shift lever.

For example, as shown in FIG. 1, a transmission cable 100 passes through a dash panel D. A cable socket 110 for connecting one side of a transmission T or one side of a shift lever L with the transmission cable 100 and a mass damper 120 for reducing the vibration of the transmission cable 100 are installed an end of the transmission cable 100.

Referring to FIGS. 2 and 3, the cable socket 110 includes a casing cap 111 and a guide pipe 112 which is integrally formed with a rubber damper 115 connected to each other inside an internal housing 114. An external housing 113 is mounted to an outer side of the internal housing 114.

Cable socket 110 according to such a conventional technology is fabricated by injecting the internal housing 114 and the external housing 113 upon an assembly of a casing cap 111 and a rubber damper 115 engaged to each other. However, the rubber damper 115 is deformed by a high temperature and a high pressure applied at the time of injection molding.

That is, the high pressure in the atmosphere of high temperature is transferred to the rubber damper 115 from the outsides of the internal housing 114 and the external housing 113 at the time of injection molding. At this time, the rubber damper 115 is deformed by an injection pressure in the state of high temperature. Therefore, the hardness value of the rubber damper 115 is not maintained, and thus, the rubber damper 115 does not demonstrate a desired vibration isolation performance.

When only one single rubber damper 115 is mounted, the vibration transferred from the transmission T to one side of the cable socket 10 is transferred to a shift lever L as it is without damping, and thereby, a noise enters inside the vehicle.

Furthermore, as an additional mass damper 120 adapted for vibration isolation has to be installed at a middle of the transmission cable 100, a vehicle weight increases and the production cost is also increased. In addition, an additional process such as calking in the intermediate portion of the transmission cable 100 has to be performed to mount the mass damper 120 and thus the assembly efficiency is lowered. Moreover, the position of the mass damper 120 inside an engine room in high temperature is difficult.

### SUMMARY

The present disclosure is to solve the problem described above, and an aspect of the embodiment provides a cable socket having an isolation function for preventing deformation of an internal member due to pressure during injection molding and achieving a desired isolation performance by preventing the deformation of the internal member, and a transmission cable including the same.

A cable socket having an isolation function according to the present disclosure is attached to an end of a transmission cable for connecting a transmission disposed in an engine compartment of a vehicle and a shift lever installed inside the vehicle includes a casing cap and a guide pipe connected to each other in the cable socket and extending outwardly from the cable socket. A rubber damper is attached to the casing cap at which the casing cap and the guide pipe are connected. An internal housing has an end of the guide pipe being inserted therein. An external housing is attached to the internal housing, in which the casing cap and the rubber damper are inserted. A pressure blocking member is inserted between the rubber damper and the external housing to block a pressure applied to the external housing from being transferred to the rubber damper.

The pressure blocking member may be a metal cap in which the rubber damper is inserted and may be formed of a metal material.

The metal cap may have a cylindrical shape through which the casing cap passes at one side and the rubber damper is inserted at another side.

The rubber damper may be attached to an outer side of the casing cap and the guide pipe inside the internal housing. The external housing, which encloses the metal cap, may be formed by injection molding while the rubber damper is inserted in the metal cap.

The rubber damper may include a first rubber damper and a second rubber damper. The first damper may enclose an end of the casing cap, and the second rubber damper may enclose an end of the guide pipe.

A transmission cable for connecting a transmission disposed in an engine compartment of a vehicle and a shift lever installed inside the vehicle to transfer an operating force of the shift lever to the transmission includes at least one cable socket having an isolation function. The cable socket may include a casing cap and a guide pipe connected to each other in the cable socket and extending outwardly from the cable socket in opposite directions. A rubber damper is attached to the casing cap at which the casing cap and the guide pipe are connected. An internal housing has an end of the guide pipe is inserted therein. An external housing is attached to the internal housing, in which the casing cap and the rubber damper are inserted. A pressure blocking member is inserted between the rubber damper and the external housing to block a pressure applied to the external housing from being transferred to the rubber damper.

According to the cable socket having isolation function and a transmission cable including the same according to one embodiment, deformation of a rubber member can be prevented by having a metal cap therein.

In addition, as the deformation of the rubber member is prevented, vibration isolation performance is achieved, thereby removing a mass damper of the conventional art to reduce the vibration and preventing noise generated at the transmission at the time of the vehicle running being entering the inside of the vehicle.

### BRIEF DESCRIPTION OF THE DRAWINGS

FIG. 1 is a perspective view of a transmission cable to which a cable socket is applied according to the prior art.

FIG. 2 is a sectional view of a cable socket according to the prior art.

FIG. 3 is an exploded perspective view of a cable socket according to the prior art.

FIG. 4 is a transmission cable to which a cable socket having an isolation function is applied according to one embodiment of the present inventive concept.

FIG. 5 is a sectional view of a cable socket having an isolation function according to one embodiment of the present inventive concept.

FIG. 6 is a perspective view of a metal cap applied to a cable socket having an isolation function according to one embodiment of the present inventive concept.

FIG. 7 is an exploded perspective view of a cable socket having an isolation function according to one embodiment of the present inventive concept.

FIG. 8 is a sectional view illustrating a pressure distribution during injection molding a cable socket having an isolation function according to one embodiment of the present inventive concept.

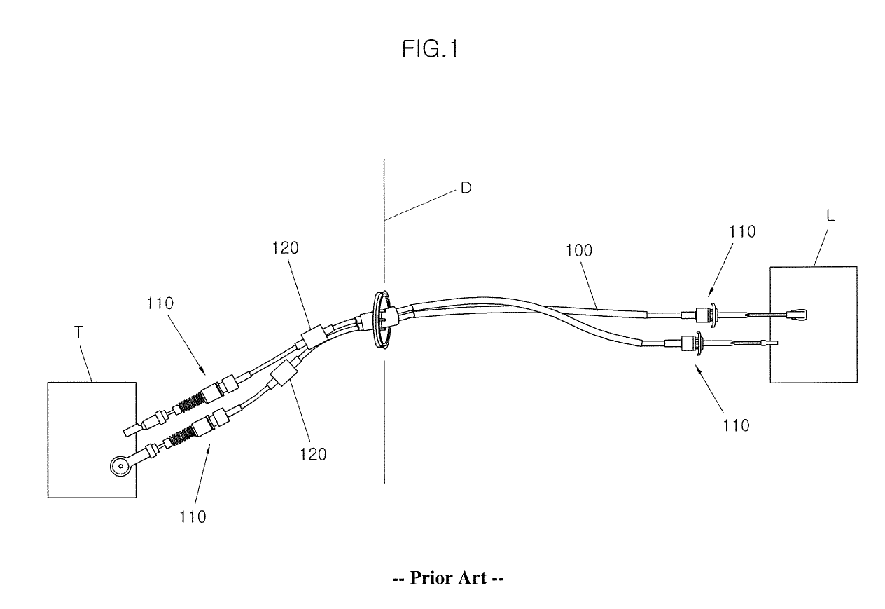

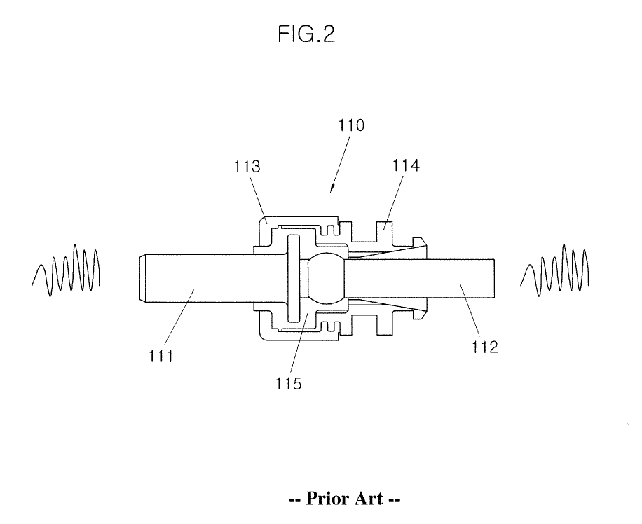

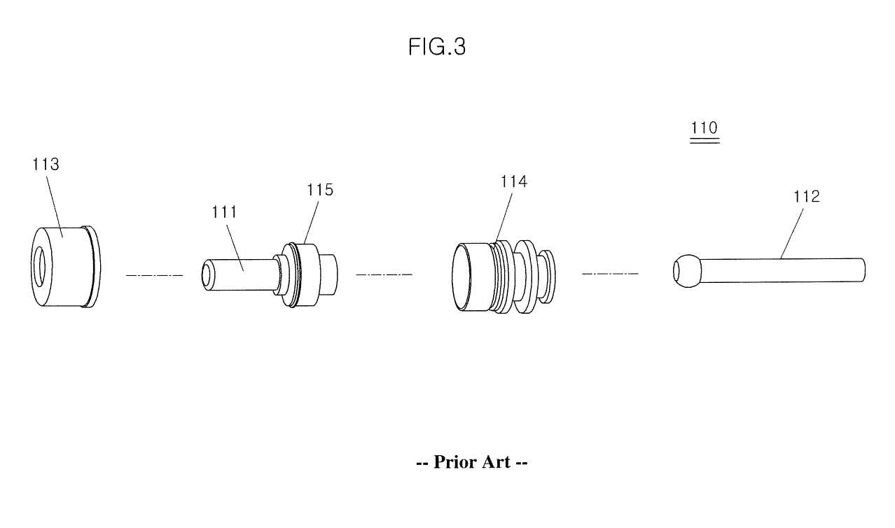

### DESCRIPTION OF SPECIFIC EMBODIMENTS

The terms and words used in the specification and claims should not be construed as their ordinary or dictionary sense. On the basis of the principle that the inventor can define the appropriate concept of a term in order to describe his/her own invention in the best way, it should be construed as meaning and concepts for complying with the technical idea of the present disclosure. Accordingly, the embodiments described in the present specification and the construction shown in the drawings are nothing but one embodiment of the present inventive concept, and it does not cover all the technical ideas of the invention. Thus, it should be understood that various changes and modifications may be made at the time of filing the present application. In addition, detailed descriptions of functions and constructions well known in the art may be omitted to avoid unnecessarily obscuring the gist of the present disclosure. Exemplary embodiments of the present inventive concept will be described below in more detail with reference to the accompanying drawings.

A cable socket having an isolation function according to embodiments of the present inventive concept will be described below in more detail with reference to the accompanying drawings.

A cable socket 10 having an isolation function according to one embodiment of the present inventive concept is mounted adjacently to an end of a transmission cable wherein the transmission cable connects a transmission T mounted in an engine room of a vehicle and a shift lever L provided inside the vehicle. The cable socket 10 comprises a casing cap 11 and a guide pipe 12 protruding outwardly and connected to each other. Rubber dampers 15 and 16 are attached to the casing cap 11 at which the casing cap 11 and the guide pipe 12 are connected. An internal housing 14 houses an end of the guide pipe 12. An external housing 13 is combined to the internal housing 14 and houses the casing cap 11 and the rubber dampers 15 and 16. A pressure blocking member is inserted between the rubber dampers 15, 16 and the external housing 13 and blocks a pressure applied to the external housing 13 from being transferred to the rubber dampers 15, 16.

The casing cap 11 and the guide pipe 12 are connected to one side of a transmission T mounted to an engine room or to one side of a shift lever L mounted to an inner side of the vehicle or connected to a wire for transferring an operating force.

For example, the casing cap 11 may be connected to one side of the transmission T or one side of the shift lever L, and the guide pipe 12 may be connected to the wire of the transmission cable 1.

The casing cap 11 and the guide pipe 12 are connected by facing each other at the opposite ends, thereby transferring the operating force to the transmission T while operating the shift lever L.

The casing cap 11 is disposed inside the cable socket 10 partially at a connecting portion with the guide pipe 12 and an adjacent portion thereof. The remaining portion of the casing cap 11 is exposed to outside the cable socket 10.

The guide pipe 12 extends outwardly from the cable socket 10.

The rubber dampers 15 and 16 prevent vibration and noise from being transferred through the casing cap 11 and the guide pipe 12.

The rubber dampers 15 and 16 are formed of rubber material. The rubber dampers 15 and 16 are mounted to the casing cap 11 at the connected portion f the casing cap 11 and the guide pipe 12.

The rubber dampers 15 and 16 are a first rubber damper 15 and a second rubber damper 16, respectively. The first rubber damper 15 is attached to an end of the casing cap 11 and the second rubber damper 16 is attached to an end of the guide pipe 12 and at the end of the casing cap 11.

The first rubber damper 15 and the second rubber damper 16 are adjacent to or in contact with each other in the assembled state, thereby blocking the vibration and noise transferred from a transmission T.

Particularly, the vibration transferred from the transmission T is transferred to the first rubber damper 15 installed at the side of the transmission T of two rubber dampers 15 and 16. The remaining vibration is isolated by the second rubber damper 16 installed at a relatively inner side to the first rubber damper 15. Therefore, the vibration generated at the transmission T is prevented from being transferred to the shift lever L. As two rubber dampers 15 and 16 are installed in the inside of the cable socket 10, the vibration generated at the transmission T may be isolated and thus a conventional mass damper is unnecessary.

Furthermore, the first rubber damper 15 and the second rubber damper 16 are formed of the same material or different kinds of materials to have different vibration isolation characteristics.

The internal housing 14 covers the end of the guide pipe 12 and the rubber dampers 15, 16. As the casing cap 11, the guide pipe 12, and the rubber dampers 15, 16 are assembled together, the guide pipe 12 is inserted in the internal housing 14.

The external housing 13 is installed on an outer side of the internal housing 14, in which a portion of the external housing 13 is overlapped with the internal housing 14. The external housing 13 covers the remaining portion which the internal housing 14 does not cover, i.e., a side of the casing cap 11. The external housing 13 may be formed by injection molding.

The pressure blocking member is inserted between the rubber dampers 15, 16 and the external housing 13. The pressure blocking member prevents the pressure applied at the time of injection molding from being transferred to the rubber dampers 15, 16. Here, the pressure blocking member is formed of a metal material which does not deform even when the pressure is applied. The pressure blocking member has a hollow in which the rubber dampers 15, 16, etc. are inserted.

FIG. 6 shows an example of the pressure blocking member as a metal cap.

The metal cap 17 has one side being open such that the casing cap 11 may pass through the metal cap 17 and another side being open such that the rubber dampers 15, 16 may be inserted into the metal cap 17 in the process of the assembly.

At the time of injection molding, a high pressure is applied with a high temperature to inject the external housing 13. However, since the metal cap 17 is formed of a metal material, the pressure applied at the time of injection molding is not transferred to the inside of the metal cap 17. Therefore, the rubber dampers 15 and 16 mounted in the inside of the metal cap 17 may be prevented from being deformed.

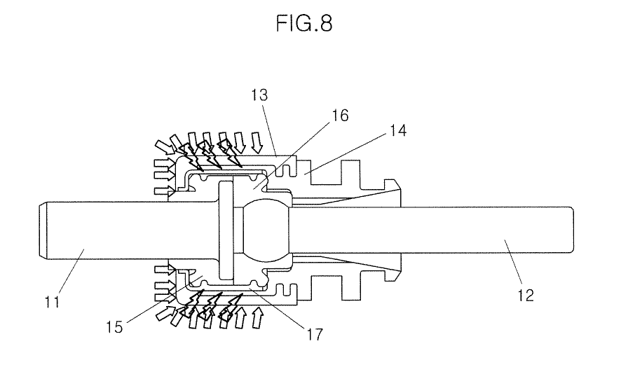

As shown in FIG. 8, a pressure applied from outside at the time of injection molding of the external housing 13 is dispersed by the metal cap 17 without concentration of the pressure on a specific region. The rubber dampers 15 and 16 may be prevented from being deformed by the application of the concentrated pressure to the rubber dampers 15 and 16.

According to the cable socket having isolation function as described above, vibration generated at the transmission T is sufficiently removable at the cable socket 10 and thus the mass damper is unnecessary. Furthermore, at the time of fabricating the cable socket 10 the metal cap 17 prevents the injection pressure from being transferred to the rubber dampers 15 and 16, thereby demonstrating sufficient isolation performance.

The transmission cable 1 including the cable socket having the isolation function according to the embodiment, which connects the transmission T at the engine room and the shift lever L inside the vehicle, includes at least one cable socket described above at the middle thereof.

The transmission cable 1 has a simple configuration and may prevent the vibration from occurring at the inside of the vehicle because the vibration generated at the transmission T is doubly isolated through the first and second rubber dampers 15 and 16.

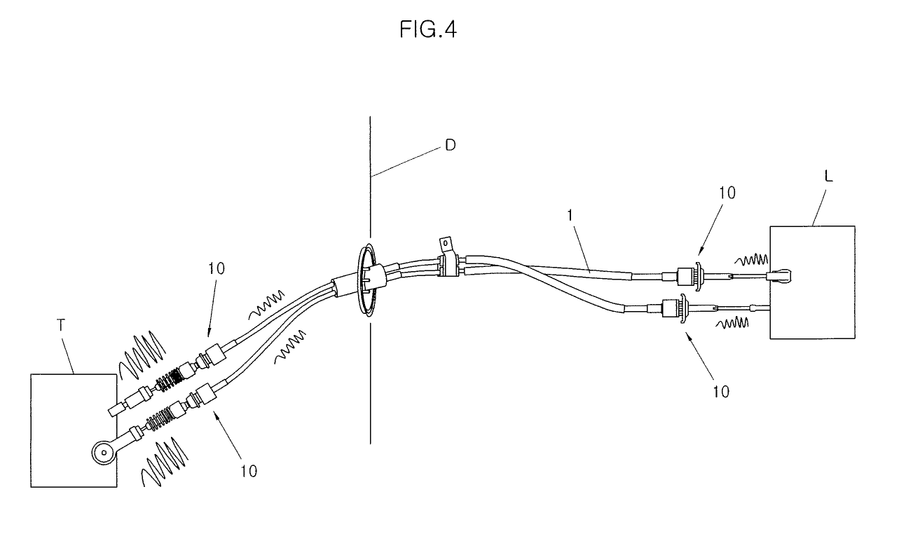

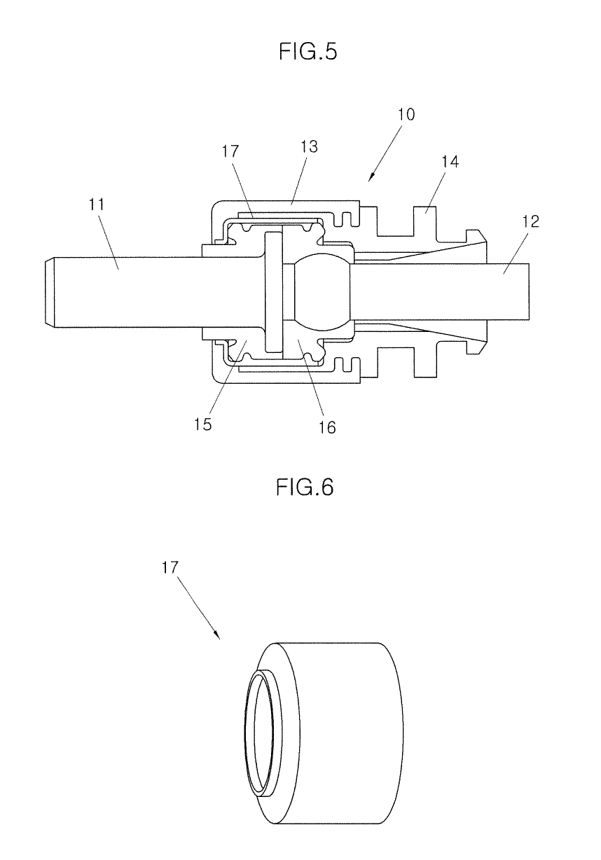

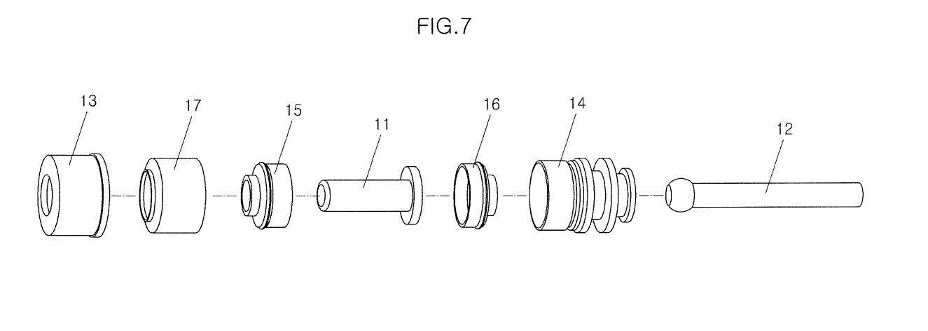

For example, as shown in FIG. 4, the vibration caused by the transmission T may remove efficiently through a plurality of cable sockets 10.

While the present invention has been described with respect to the specific embodiments, it will be apparent to those skilled in the art that various changes and modifications may be made without departing from the spirit and scope of the invention as defined in the following claims.

What is claimed is:

1. A cable socket having an isolation function attached to an end of a transmission cable which connects a transmission disposed in an engine compartment of a vehicle and a shift lever inside the vehicle, the cable socket comprising:
a casing cap and a guide pipe connected to each other in the cable socket and extending outwardly from the cable socket in opposite directions;
a rubber damper attached to the casing cap at which the casing cap and the guide pipe are connected;
an internal housing in which an end of the guide pipe is inserted;
an external housing attached to the internal housing and in which the casing cap and the rubber damper are inserted; and
a pressure blocking member inserted between the rubber damper and the external housing to block a pressure applied to the external housing from being transferred to the rubber damper.

2. The cable socket of claim 1, wherein the pressure blocking member is a metal cap in which the rubber damper is inserted and is formed of a metal material.

3. The cable socket of claim 2, wherein the metal cap has a cylindrical shape through which the casing cap passes at one side and the rubber damper is inserted at another side.

4. The cable socket of claim 2, wherein the rubber damper is attached to an outer side of the casing cap and the guide pipe inside the internal housing, and
the external housing, which encloses the metal cap, is formed by injection molding while the rubber damper is inserted in the metal cap.

5. The cable socket of claim 1, wherein the rubber damper comprises a first rubber damper and a second rubber damper, and
the first damper encloses an end of the casing cap and the second rubber damper encloses an end of the guide pipe.

6. A transmission cable for connecting a transmission inside an engine compartment and a shift lever inside a vehicle to transfer an operating force of the shift lever to the transmission, the transmission cable including at least one cable socket which has an isolation function,
wherein the cable socket comprising:
a casing cap and a guide pipe connected to each other in the cable socket and extending outwardly from the cable socket in opposite directions;
a rubber damper attached to the casing cap at which the casing cap and the guide pipe are connected;
an internal housing in which an end of the guide pipe is inserted;
an external housing attached to the internal housing and in which the casing cap and the rubber damper are inserted; and
a pressure blocking member inserted between the rubber damper and the external housing to block a pressure applied to the external housing from being transferred to the rubber damper.
